(19) United States
(12) Patent Application Publication
(10) Pub. No.: US 2004/0258373 A1
(43) Pub. Date: Dec. 23, 2004

(54) Monitoring cable

(76) Inventor: Jon Steinar Andreassen, Slattum (NO)

Correspondence Address: SOFER & HAROUN, L.L.P., 317 Madison Avenue, Suite 910, New York, NY, 10017, US

(21) Appl. No.: 10/826,144

(22) Filed: Apr. 15, 2004

(30) Foreign Application Priority Data
May 12, 2003 (NO) 2003 2119

(51) Int. Cl. G02B 6/44

(52) U.S. Cl. 385/100

(57) ABSTRACT

The present invention relates to the field of cables comprising optical means for monitoring temperature and strain. More precisely, the invention provides a cable 1 comprising an outer protective sheath 2 and optical means for monitoring temperature and strain, said optical means being within said outer protective sheath 2 and comprising a first tube 4 including at least a first optical fibre 8 in order to monitor the temperature, said first optical fibre 8 being loose in said first tube 4 and comprising at least one reflecting section called Bragg grating and at least a second optical fibre 7 including at least one Bragg grating in order to monitor the strain. Said second optical fibre 7 is outside said first tube 8, said optical means further comprising means 6 for tightening said second optical fibre 7.

The present invention relates to the field of cables comprising optical means for monitoring temperature and strain.

It is well known to provide a cable comprising optical means for monitoring temperature and strain.

The document EP1235089 discloses such a cable comprising a steel tube; said tube includes at least two optical fibres for each kind of monitoring, each optical fibre comprising a small reflecting section formed in the core and called “Bragg grating”. The Bragg grating is a periodic modulation of the index of refraction in the optical fibre core and reflects one particular wavelength determined by this modulation. The local modulation is induced into the metal ion doped fibre core by radiating the fibre with a multidimensional UV pattern, so that a small plane is formed in the core.

A strain and/or a change in temperature causes the reflected wavelength to be shifted due to changes in the modulation period. Typically, for a long period grating, a wavelength of 1550 nm shifts by about 1 to 1.5 nm per 100° C. change in temperature and by about 0.12 nm per 100 microstrain change in strain (the unit conversion between strain and microstrain, expressed as a dimensionless ratio, is 10⁶ microstrain/strain, the strain itself being dimensionless).

In the known patent application, the optical fibre for temperature monitoring is loose in the tube; in such a way, the optical fibre for temperature monitoring is only influenced by thermal expansion and is totally free from mechanical stresses. In order to have a loose fibre that moves freely within the tube during mechanical elongation, the fibre has an excess length.

The optical fibre for strain monitoring is locally glued to the tube wall. In such a way, when the cable is locally subjected to an elongation between the locations where the optical fibre is fixed, the optical fibre is also subjected to an elongation and the local strain can be measured.

This solution raises some difficult problems because of manufacturing process. It is indeed very difficult to provide in the same tube both loose and tight fibres. The process of encapsulating optical fibres in steel tube is a delicate one. The optical fibres are guided from their individual pay-offs through a small capillary into the formed steel strip. A loose fibre (fibre with excess length) is obtained by tuning several process parameters such as tension on fibres. Mixing loose and tight fibres (fibres without excess length) in the same tube would have to imply a huge difference in tension on fibres during this process. In addition, different stresses in fibres would lead to different fibre movements during cable installation and operations and most likely cause severe fibre loss or failure.

Moreover, by using some glue in order to provide the fibre for strain monitoring, there is also a risk that such a fibre may be fixed accidentally during manufacture to another fibre such as the fibre for temperature monitoring.

One object of the present invention is to provide a cable comprising optical means for monitoring temperature and strain, said cable being provided without using glue and being easier to manufacture in a low cost manner.

More precisely, the invention provides a cable comprising an outer protective sheath and optical means for monitoring temperature and strain, said optical means being within said outer protective sheath and comprising:

a first tube including at least a first optical fibre in order to monitor the temperature, said first optical fibre being loose in said first tube and comprising at least one reflecting section called Bragg grating,

at least a second optical fibre including at least one Bragg grating in order to monitor the strain,

said cable being characterized in that said second optical fibre is outside said first tube, said optical means further comprising means for tightening said second optical fibre.

Thus, according to the invention, there is a physical split between the fibre used to monitor the temperature and the fibre used to monitor the strain. This split is obtained by encapsulating separately said first and second optical fibre. Said first optical fibre is loose in a first tube and allows to monitor the temperature without being influenced by strain. Said second optical fibre is tight in order to ensure a simple transfer-function of strain between the cable and a the first fibre. Therefore, there is no need of differentiating tension on individual fibres during the tube manufacturing, because the two types of fibres are physically separated. Moreover, there is no need to use some glue in order to fix the strain monitoring fibre that is tightly maintained by said means for tightening.

Advantageously, said second optical fibre is centrally located along the longitudinal axis of said cable.

This is particularly advantageous when said cable comprises a stranded layer including a plurality of strands and said means for tightening said second optical fibre are a second tube; in such a case, if said second optical fibre is not centrally located along the longitudinal axis of said cable, there is a risk of bending of said second tube due to stranding. Such a bending is going to induce an undesired fibre strain relief.

Advantageously, said first optical fibre has an excess length in said first tube.

Thus, a first way in order to provide a loose optical fibre with strain relief is to provide an excess length of said fibre in the first tube so that the fibre remains strain free even though the cable is elongated.

Advantageously, said first tube is stranded.

Thus, a second way in order to provide a loose optical fibre with strain relief is to provide a stranded first tube. By stranding the first tube, more excess length may be implemented than by only using an excess length of the fibre in the first tube.

An advantageous solution consists in combining first and second ways by providing a small excess length of fibre within the first tube combined with a stranded first tube.

Furthermore, said cable comprises a stranded layer including a plurality of strands, one of said strands being said first tube.

In a first embodiment, one of said strands is a strength member.

In a second embodiment, one of said strands is a conductor.

Advantageously, said first tube comprises a plurality of optical fibres.

Therefore, said first tube can comprise at the same time temperature sensing optical fibre and standard optical fibre for telecommunication purpose. In other words, said cable may be at the same time a telecommunication cable and a monitoring cable.

In a first embodiment, means for tightening said second optical fibre are a second tube separated from said first tube.

According to the above-mentioned embodiment, said second tube may comprise several primary coated fibres having none or slightly negative excess length.

According to the above-mentioned first embodiment, advantageously, said second tube comprises a plurality of optical fibres.

Advantageously, at least one of said first or second tube is made of metal.

In a second embodiment, said means for tightening said second optical fibre are a coating layer surrounding tightly said second optical fibre in order to form a tight-buffered fibre.

Advantageously, at least one of said first or second optical fibre comprises a plurality of Bragg gratings disposed at different locations along the length of said first or second optical fibre, each of them corresponding to a monitoring spot.

Furthermore, said means for tightening said second optical fibre are surrounded by a protective jacket.

Other characteristics and advantages of the invention will appear on reading the following description of embodiments of the invention, given by way of example and with reference to the accompanying drawings, in which:

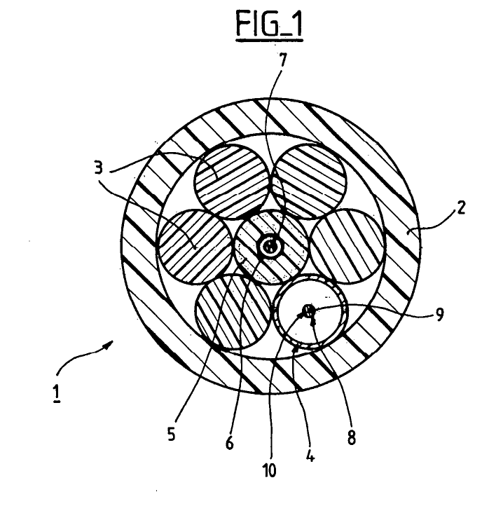

FIG. 1 schematically shows a cross-sectional view of a cable according to a first embodiment of the invention,

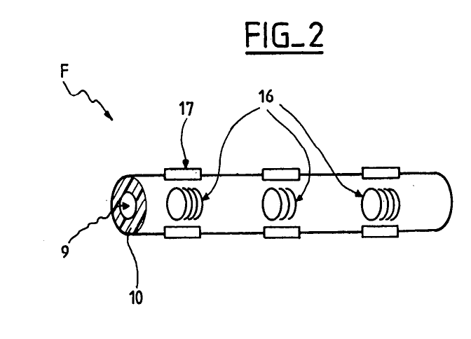

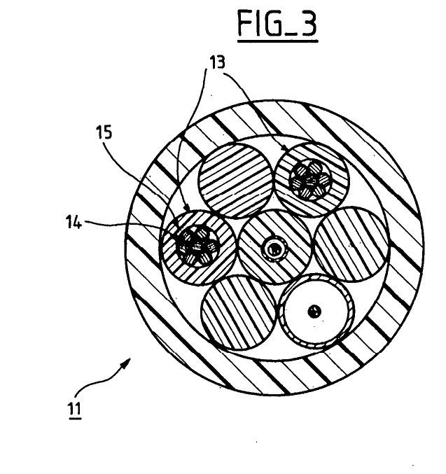

FIG. 2 schematically shows an optical fibre with Bragg gratings as used in a cable according to the invention, FIG. 3 schematically shows a cross-sectional view of a cable according to a second embodiment of the invention.

FIG. 1 schematically shows a cross-sectional view of a cable 1 according to a first embodiment of the invention.

The cable 1 comprises starting from outside to inside:

an outer protective sheath 2,

a stranded layer including five strength members 3 and a first tube 4 comprising a first optical fibre 8 for temperature monitoring,

an inner protective sheath 5,

a second tube 6 comprising a second optical fibre 7 for strain monitoring.

The second tube 6 is centrally located along the longitudinal axis of the cable 1 and includes in a tightly manner the second optical fibre 7. The second tube 6 may also comprise a plurality of optical fibres and be filled with a filling compound in order to maintain tightly said plurality of optical fibres.

The system comprising the second tube 6 and the second optical fibre 7 may also be replaced by a tight-buffered optical fibre, i.e. a coating layer surrounding tightly the second optical fibre.

The second tube is surrounded by the inner protective sheath 5.

The five strength members 3 and the first tube 4 are twisted helically around the inner protective sheath 5 in order to form the stranded layer.

The stranded layer is surrounded by the outer protective sheath 2.

The material used for the inner and outer protective sheaths can be for instance a polymer material selected according to the environment; typically, it may be polyethylene PE; however, it may also be a fluorpolymer material for elevated temperatures or aggressive environment; in buildings or tunnels, low smoke halogen free materials may also be used.

Strength members 3 can be made of steel, glass reinforced polymers or other composite material; again, the environment and the nature of the application are going to determine the material used.

In some case where axial strength is not an issue, one can also use polymeric filler strands instead of strength members.

First and second tubes can be made of a metal such as a stainless steel (for instance standards AISI 304 and AISI 316). For special environments, other materials may also be used (for instance Ni—Cr alloys such as standards UNS N08825 and UNS N006625).

Each of said first and second optical fibres 8 and 7 comprise in a known manner a glass fibre 9 provided with a coating 10. FIG. 2 schematically shows such an optical fibre F.

At regular intervals, the optical fibre F further comprises Bragg gratings 16 forming a measuring sensor. The coating 10 is removed at the locations where a Bragg grating is to be imprinted. After finishing the formation of a Bragg grating, the removed coating 10 is replaced by a special coating 17 or by a metallic vapour deposit. Each of the Bragg gratings 16 corresponds to a monitoring spot.

The first optical fibre 8 is loose in the first tube 4. In order to obtain a strain relief for the first fibre 8 that is only used for temperature sensing, this first fibre 8 must indeed have a defined excess length (“loose” fibre) so that it remains strain free even though the cable 1 is elongated. This excess length may be implemented in the tubing process; however by stranding the first tube 4, more excess length may be implemented without running the risk of exposing the first fibre 8 to buckling, as this may cause poor repeatability of fibre position in tube versus cable load. It is suggested to have a small fibre excess length within the first tube 4 and to strand the first tube 4 in a proper manner for obtaining required strain relief of fibre.

The second optical fibre 7 is maintained in a tightly manner by the second tube 6 along the longitudinal axis of cable 1 ensuring therefore a simple transfer function of strain between the cable 1 and the second optical fibre 7.

When the cable 1 is submitted to a strain, the loose first optical fibre 8 is allowed to move freely in the first tube 4. Due to the stranding of the first tube 4, there is an “inner path” for the first tube 4 along the inner protective sheath 5 and the first optical fibre 8 remains strain free. Therefore, the Bragg gratings in the first optical fibre are only affected by temperature whereas the Bragg gratings in the second optical fibre 7 are affected by cable strain and temperature.

Such a cable 1 may be for instance directly embedded in concrete structures such as buildings or bridges or in large umbilical or pipelines.

FIG. 3 schematically shows a cross-sectional view of a cable 11 according to a second embodiment of the invention.

The cable 11 has a structure similar to the one of the cable 1 as shown in FIG. 1 except that two of the strength members represented in FIG. 1 are replaced by two electrical power cables 13.

Each of the electrical power cables 13 comprises a central conductive core 14 including six conductive outer strands twisted helically around a central strand. A sheath 15 surrounds the conductive core 14.

Naturally, the present invention is not limited to the examples and embodiments described and shown and the invention can be the subject of numerous variants that are available to the person skilled in the art.

The first tube has been described as comprising only one first optical fibre with Bragg gratings but it can also comprise at the same time standard optical fibre for telecommunication purpose. In such a way, the cable may be at the same time a telecommunication cable and a monitoring cable.

Similarly, the number of tubes in the stranded layer can be greater than one.

It is also possible to provide several stranded layers, for instance a first stranded layer comprising tubes and power conductors and a second stranded layer comprising strength members.

1. Cable comprising:
an outer protective sheath and optical means for monitoring temperature and strain, said optical means being within said outer protective sheath and having
a first tube including at least a first optical fibre in order to monitor the temperature, said first optical fibre being loose in said first tube and comprising at least one reflecting section called Bragg grating; and
at least a second optical fibre including at least one Bragg grating in order to monitor the strain, wherein in
said cables being characterized in that said second optical fibre is outside said first tube, said optical means further comprising means for tightening said second optical fibre.

2. Cable according to claim 1 wherein said second optical fibre is centrally located along the longitudinal axis of said cable.

3. Cable according to claim 1 wherein said first optical fibre has an excess length in said first tube.

4. Cable according to claim 1 wherein said first tube is stranded.

5. Cable according to claim 1 further comprising a stranded layer including a plurality of strands, one of said strands being said first tube.

6. Cable according to claim 1 wherein said first tube comprises a plurality of optical fibres.

7. Cable according to claim 1 wherein said means for tightening said second optical fibre are a second tube separated from said first tube.

8. Cable according to claim 7 wherein said second tube comprises a plurality of optical fibres.

9. Cable according to claim 1 wherein said means for tightening said second optical fibre are a coating layer surrounding tightly said second optical fibre in order to form a tight buffered fibre.

10. Cable according to claim 1 wherein at least one of said first or second optical fibre comprises a plurality of Bragg gratings disposed at different locations along the length of said first or second optical fibre, each of them corresponding to a monitoring spot.

11. Cable according to claim 1 wherein said means for tightening said second optical fibre are surrounded by a protective jacket.

12. Cable according to claim 5 wherein one of said strands is a strength member.

13. Cable according to claim 5 wherein one of said strands is a conductor.

14. Cable according to claim 1 wherein at least one of said first or second tube is made of metal.
